(19) United States
(12) Patent Application Publication
(10) Pub. No.: US 2013/0063662 A1
(43) Pub. Date: Mar. 14, 2013

(54) COMPUTER ASSISTED DEVICE AND TELEVISION RECEIVER

(71) Applicant: Jong-Ho Lee, Seoul (KR)

(72) Inventor: Jong-Ho Lee, Seoul (KR)

(73) Assignee: SK TELESYS CO., LTD., Seoul (KR)

(21) Appl. No.: 13/699,680

(22) PCT Filed: Jan. 11, 2011
(86) PCT No.: PCT/KR2011/000187

§ 371 Date: Nov. 23, 2012

(30) Foreign Application Priority Data
Jun. 29, 2010 (KR) 10-2010-0061912

(51) Int. Cl. H04W 88/02; H04N 5/44

(52) U.S. Cl. 348/552; 455/557; 348/E05.096

(57) ABSTRACT

The present invention relates to a smartphone. According to the present invention, provided are a computer assisted device and a television receiver capable of functioning as one complete computer combined with a smartphone. Accordingly, the smartphone owner may not need to purchase an additional expensive computer, and device portability may be improved.

### TECHNICAL FIELD

The present invention relates to a technique of a smart phone.

### BACKGROUND ART

Like PDA phones having telephone functions, which have started by inserting a mobile communication module into a PDA by a company developing PDAs, smart phones are developed by mounting PDA functions onto cellular phones by companies developing mobile communication terminals. The smart phones are almost similar to the PDA phones, and their functions are slightly different from those of general PDA phones, or additional functions are added to the functions of the cellular phones, and thus volume of a smart phone is rather large. However, as the boundary between the PDA phones and the smart phones is gradually collapsed, these two phones are commonly referred to as a smart phone.

Simon is the first smart phone. It is designed by IBM USA in 1992 and exhibited as a concept product at the Comdex show held in Las Vegas, Nev. in USA in the same year.

Then, first smart phones of Nokia have been developed in 1996 starting from Nokia 9000, and Nokia 9210 is the first real smart phone, which is the first color screen communicator model having an open operating system.

As is known from iPhones of Apple of US or Google phones of Google, a smart phone has become an almost perfect portable computer having a proprietary operating system since performance is improved and functions are added owing to advancement in peripheral techniques (memory semiconductors and the like) and continuous development.

Meanwhile, although portable tablet PCs (PCs handled only through a touch screen without a separate keyboard) have not attracted much attention until recently, they are spotlighted when Apple has announced iPad.

Although a program similar to that of iPhone is mounted on the iPad, the iPad provides extended functions suitable for a wide screen and improved functions.

As described above, owing to the brilliant progress in peripheral techniques, the gap between the smart phones and the portable computers has been narrowed as close as can be.

### DISCLOSURE OF INVENTION

### Technical Problem

Therefore, the present invention has been made in view of the above problems, and it is an object of the present invention to provide a computer assistant apparatus that can be combined with a smart phone.

Another object of the present invention is to provide a television receiver that can be combined with a smart phone.

### Technical Solution

To accomplish the above object, according to one aspect of the present invention, there is provided a computer assistant apparatus including: an input unit for inputting a user command into a smart phone; a display unit for displaying information requested to be displayed in a series of works performed in the smart phone in response to the user command inputted through the input unit; and a connection unit electrically contacting with the smart phone in order to exchange electrical signals with the smart phone.

The connection unit preferably has an insertion hole for inserting the smart phone.

The input unit is preferably provided as a touch screen.

The computer assistant apparatus preferably further includes a speaker unit for outputting electrical audio signals received from the smart phone as a sound.

The computer assistant apparatus preferably further includes an extension unit connected to the smart phone through the connection unit and providing extended functions that cannot be provided by the smart phone.

The extension unit preferably includes a graphic function reinforcement means for converting a graphic received from the smart phone into a graphic fitted to a dimension of a screen provided in the display unit.

The extension unit preferably includes an auxiliary memory means for memorizing information received from the smart phone.

The extension unit preferably includes an input and output means for inputting a user command into the smart phone or outputting information received from the smart phone.

According to another aspect of the present invention, there is provided a television receiver including: an input unit for inputting a user command into a smart phone; a display unit for displaying information requested to be displayed in a series of works performed in the smart phone in response to the user command inputted through the input unit; a speaker unit for outputting electrical audio signals received from the smart phone as a sound; a connection unit electrically contacting with the smart phone in order to exchange electrical signals with the smart phone; and a television receiver unit for performing a television reception function regardless whether or not the smart phone is combined.

The connection unit preferably has an insertion hole for inserting the smart phone.

The television receiver preferably further includes an extension unit connected to the smart phone through the connection unit and providing extended functions that cannot be provided by the smart phone.

The extension unit preferably includes a graphic function reinforcement means for converting a graphic received from the smart phone into a graphic fitted to a dimension of a screen provided in the display unit.

The extension unit preferably includes an auxiliary memory means for memorizing information received from the smart phone.

The extension unit preferably includes an input and output means for inputting a user command into the smart phone or outputting information received from the smart phone.

### Advantageous Effects

Since the computer assistant apparatus or the television receiver according to the present invention described above can support communications performed on a smart phone, computing works performed on offline spaces and computing works performed on the wireless Internet, the following advantages can be expected.

First, a user having a smart phone does not need to separately purchase a personal computer such as an expensive portable computer.

Second, even when a user needs to carry both the smart phone and the computer assistant apparatus, it is sufficient only to insert the smart phone into the computer assistant apparatus, and thus portability thereof is improved.

Third, since the television receiver can be connected to a smart phone and used as a computer, a user having the smart phone does not need to separately purchase a personal computer other than the television receiver.

Fourth, since functions that cannot be supported by the smart phone or separately needed functions can be further provided through extended functions, usability of the smart phone can be enhanced further more.

### BRIEF DESCRIPTION OF THE DRAWINGS

FIG. 1 a view showing the configuration of a computer assistant apparatus according to an embodiment of the present invention.

FIG. 2 a view schematically showing the outer appearance of the computer assistant apparatus of FIG. 1.

FIG. 3 a view showing the configuration of a television receiver according to an embodiment of the present invention.

FIG. 4 a view schematically showing the outer appearance of the television receiver of FIG. 3.

### BEST MODE FOR CARRYING OUT THE INVENTION

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

<Example of Computer Assistant Apparatus>

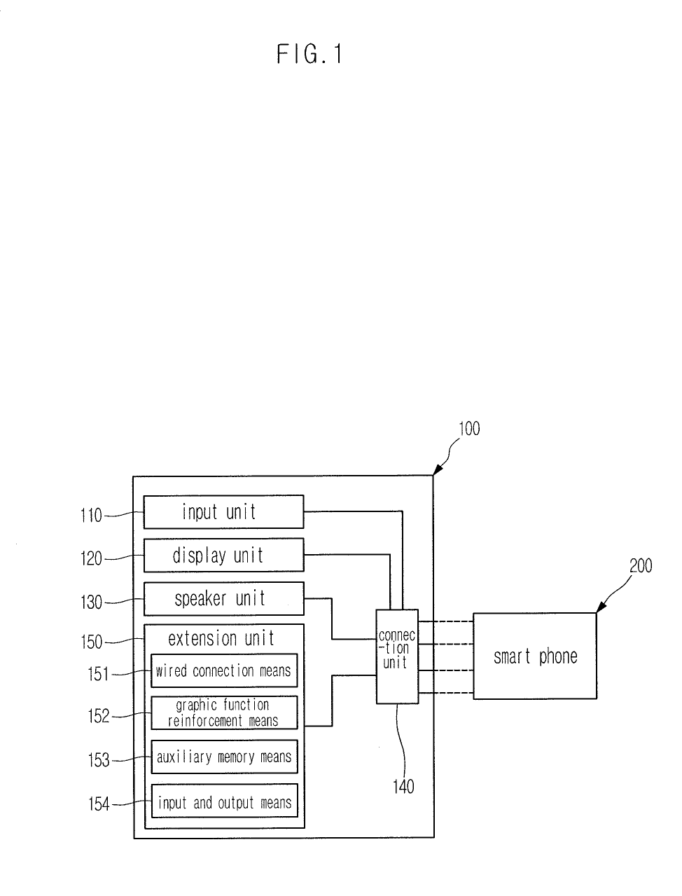

FIG. 1 a view showing the configuration of a computer assistant apparatus 100 according to an embodiment of the present invention.

As shown in FIG. 1, the computer assistant apparatus 100 according to the embodiment includes an input unit 110, a display unit 120, a speaker unit 130, a connection unit 140 and an extension unit 150.

The input unit 110 is provided to input a command (hereinafter, referred to as a user command) into the smart phone 200 in order to perform a work requested by a user in the smart phone 200 by executing a program of the smart phone 200. The input unit 110 is preferably provided as a touch screen for portability.

The display unit 120 is provided to display information requested to be displayed in a series of online or offline works performed in the smart phone 200 in response to the user command inputted through the input unit 110.

The speaker unit 130 is provided to output electrical audio signals received from the smart phone 200 as a sound.

The connection unit 140 is a part electrically contacting with the smart phone 200 in order to exchange electrical signals with the smart phone 200. Accordingly, the user command inputted through the input unit 110 is inputted into the smart phone 200 through the connection unit 140, and screen information or sound information received from the smart phone 200 is outputted through the display unit 120 or the speaker unit 130 via the connection unit 140.

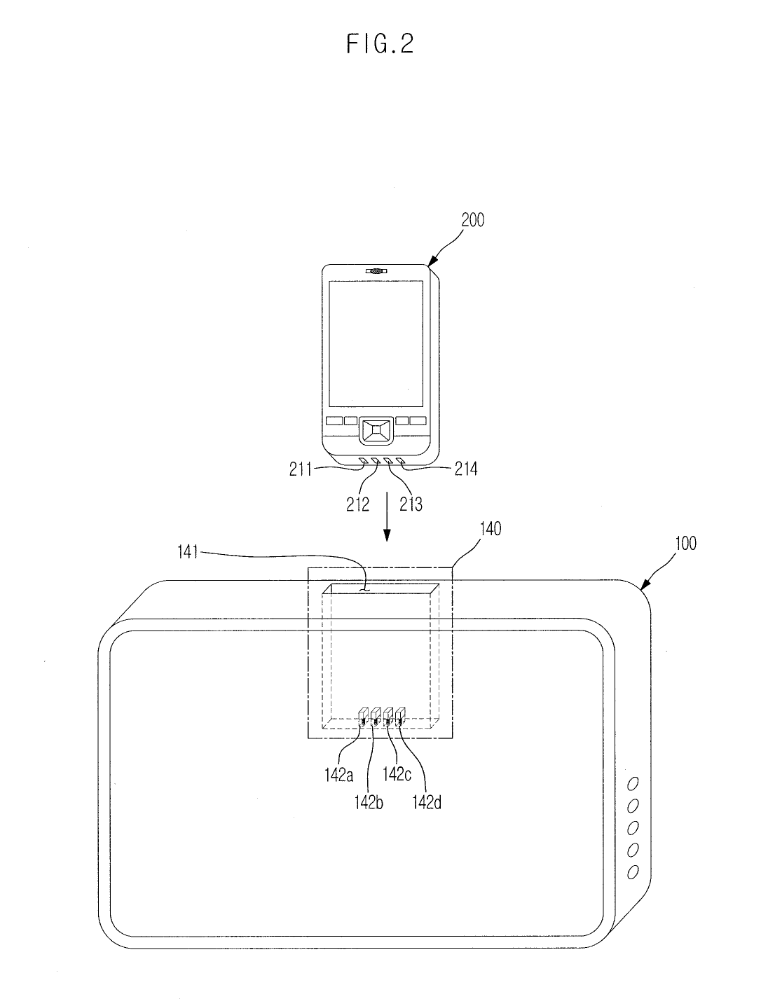

As shown in FIG. 2, the connection unit 140 has an insertion hole 141 (the insertion hole can be formed at various positions depending on embodiments) for inserting the smart phone 200. In addition, a terminal 142a for transferring screen information from the smart phone 200 to the computer assistant apparatus 100, a terminal 142b for transferring audio signals from the smart phone 200 to the computer assistant apparatus 100, a terminal 142c for transferring a user command from the computer assistant apparatus 100 to the smart phone 200, and a terminal 142d for connecting the extension unit 150 to the smart phone 200 are provided on the bottom surface of the insertion hole 141. Apparently, it is preferable that each of the terminals 142a, 142b and 142c is provided in plurality as needed.

In addition, the terminals 142a, 142b and 142c are respectively provided at positions exactly corresponding to the terminals 211, 212 and 213 of the smart phone 200. Accordingly, if the smart phone 200 is inserted into the insertion hole 141, the smart phone 200 is combined with the computer assistant apparatus 100 in a method of naturally and electrically contacting the terminals 211, 212 and 213 provided in the smart phone 200 with the terminals 142a, 141b and 141c provided in the computer assistant apparatus 100.

Apparently, it is further preferable that the connection unit 140 further includes a recharge terminal for recharging power of the continuously used smart phone 200.

Meanwhile, the extension unit 150 is provided to enhance usability of the smart phone 200 by providing extended functions that cannot be supported by the smart phone 200. The extension unit 150 is electrically connected to the smart phone 200 through the connection unit 140 and includes a wired connection means 151, a graphic function reinforcement means 152, an auxiliary memory means 153 and an input and output means 154.

When a user needs to use the Internet in a space where a wireless Internet or the like is not supported or desires to use a relatively further cheaper wired Internet, the wired connection means 151 provides the smart phone 200 with a function supporting the wired Internet service. Accordingly, when a wired Internet line is connected through the wired connection means 151, wired Internet information is provided to the smart phone 200 through the terminal of symbol 142d, returns to the computer assistant apparatus 100 through the terminals of symbols 142a and 142b, and is outputted through the display unit 120 or the speaker unit 130.

The graphic function reinforcement means 152 converts a graphic received from the smart phone 200 into a graphic fitted to the dimension of a screen and appropriate to be displayed on the display unit 120 which outputs a screen enlarged to be further larger than the screen of the smart phone 200, and furthermore, it maintains the graphic quality even in a big screen by increasing resolution of the graphic.

The auxiliary memory means 153 provides a function of memorizing information received from the smart phone 200. The auxiliary memory means 153 may selectively have volatile memory or non-volatile memory or both of these depending on embodiments. Accordingly, if a user has a new smart phone 200, information stored in the auxiliary memory means 153 is loaded onto the new smart phone 200, and computing works can be continued without interruption. In addition, since information too large to be stored in the smart phone 200 can be stored in the auxiliary memory means 153, available capacity of the smart phone 200 can be extended. In addition, a variety of application programs that the smart phone 200 may not have can be installed in the auxiliary memory means 153, and the installed application programs can be driven by the smart phone 200, and thus usability of the smart phone 200 can be enhanced.

The input and output means 154 supports to input a user command into the smart phone 200 or output information received from the smart phone through a printer. Accordingly, when a phone call is received on the smart phone 200, the user may connect or disconnect the phone call to or from the smart phone 200 or send other commands to the smart phone 200 through the input and output means 154, or it can output information through the printer if needed. In addition, the input and output means 154 may further have a connection jack or the like for connecting a microphone for inputting sounds inputted by the user or a separate keyboard depending on embodiments.

Since the configuration of the extension unit 150 described above is merely an example, the extension unit 150 can be implemented to additionally support any function that can enhance usability of the smart phone 200 although it may not be supported by the smart phone 200.

Apparently, the extension unit 150 described above is an option that can be added when such a configuration is demanded by the market.

According to the computer assistant apparatus 100 described above, it may function as a perfect mobile computer by providing a wide screen in combination with the smart phone 200, and since the smart phone 200 is combined in a method of inserting the smart phone 200, portability thereof is improved.

Accordingly, a user having a smart phone 200 does not need to separately purchase an expensive portable computer if he or she purchases only the relatively cheap computer assistant apparatus 100.

In addition, it is preferable to implement such that voice or video communication can be performed even when the smart phone 200 is combined with the computer assistant apparatus 100. Apparently, even in this case, when the user needs to move to another place (particularly when secrecy of a call is required), the smart phone 200 should keep the call connection although the smart phone 200 is detached from the computer assistant apparatus 100 and moved to another place.

<Example of Television Receiver>

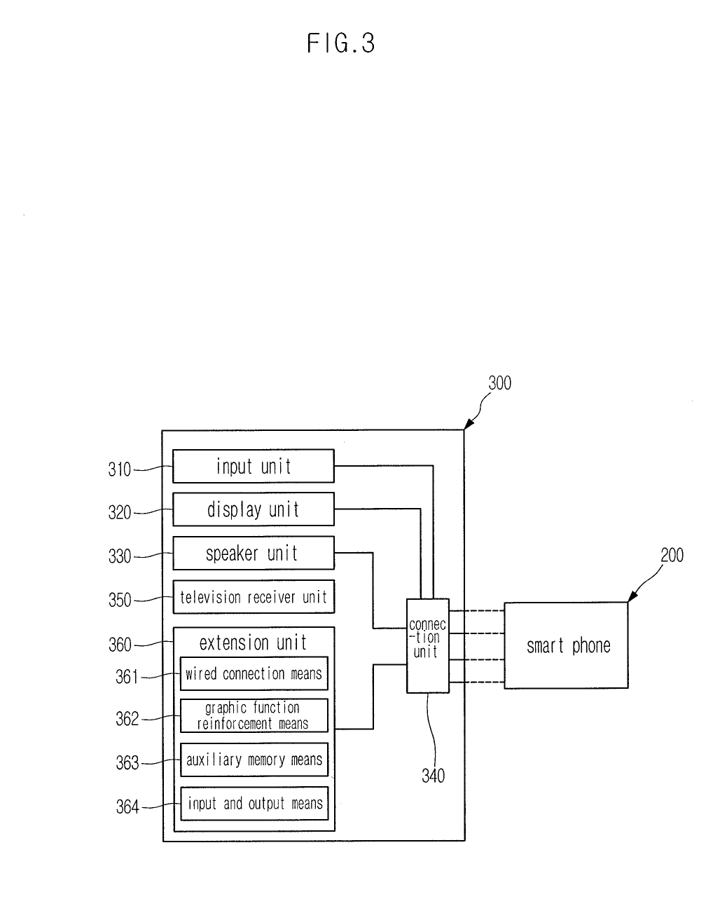

FIG. 3 a view showing the configuration of a television receiver 300 according to an embodiment of the present invention.

As shown in FIG. 3, the television receiver 300 according to the embodiment includes an input unit 310, a display unit 320, a speaker unit 330, a connection unit 340, a television receiver unit 350 and an extension unit 360.

The input unit 310 is provided to input a command (hereinafter, referred to as a user command) into the smart phone 200 in order to perform a work requested by a user in the smart phone 200 by executing a program of the smart phone 200. The input unit 310 is preferably provided as a touch screen or a separate input terminal.

The display unit 320 is provided to display information requested to be displayed in a series of works performed in the smart phone 200 in response to the user command inputted through the input unit 310.

The speaker unit 330 is provided to output electrical audio signals received from the smart phone 200 as a sound.

The connection unit 340 is a part electrically contacting with the smart phone 200 in order to exchange electrical signals with the smart phone 200. Accordingly, the user command inputted through the input unit 310 is inputted into the smart phone 200 through the connection unit 340, and screen information or sound information received from the smart phone 200 is outputted through the display unit 320 or the speaker unit 330 via the connection unit 340.

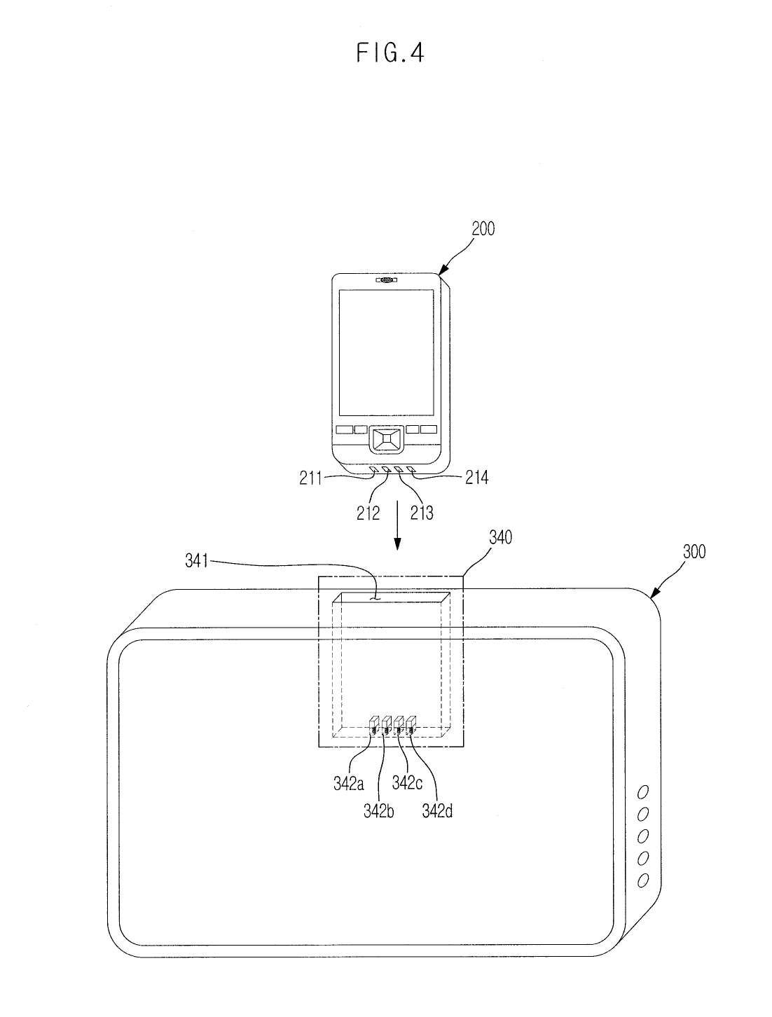

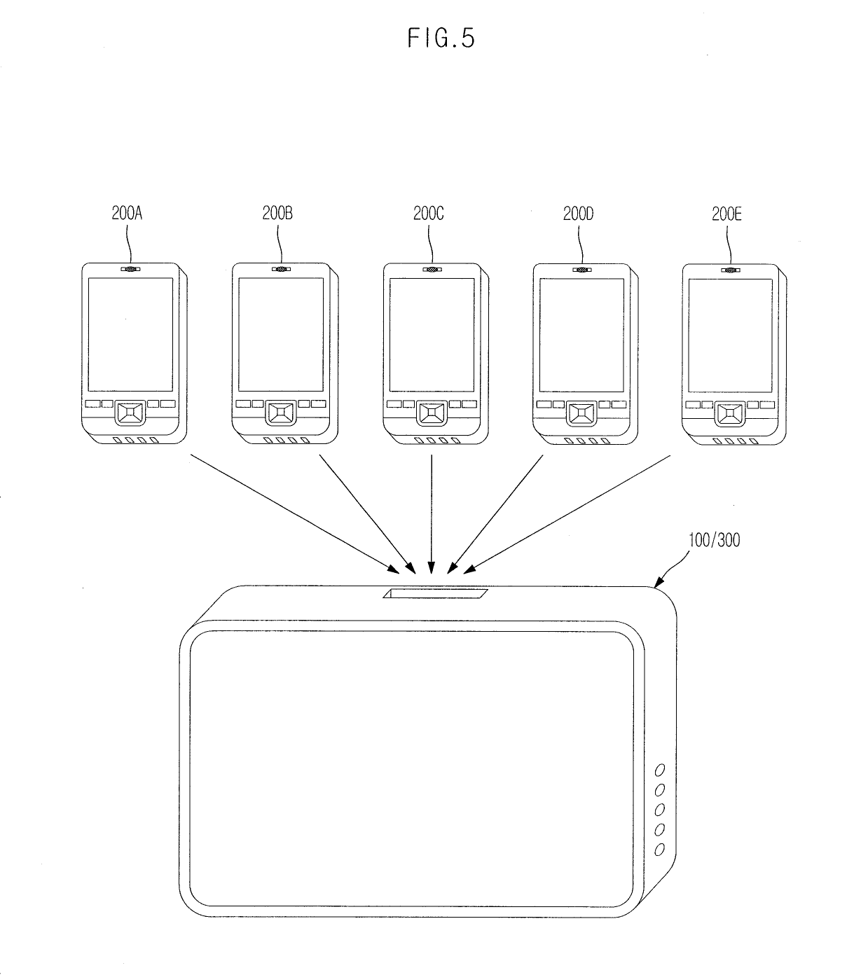

As shown in FIG. 4, the connection unit 340 has an insertion hole 341 (the insertion hole can be formed at various positions depending on embodiments) for inserting the smart phone 200. In addition, a terminal 342a for transferring screen information from the smart phone 200 to the television receiver 300, a terminal 342b for transferring audio signals from the smart phone 200 to the television receiver 300, a terminal 342c for transferring a user command from the television receiver 300 to the smart phone 200, and a terminal 342d for electrically connecting the extension unit 360 to the smart phone 200 are provided on the bottom surface of the insertion hole 341. Apparently, it is preferable that each of the terminals 342a, 342b and 342c is provided in plurality as needed.

In addition, the terminals 342a, 342b and 342c are respectively provided at positions exactly corresponding to the terminals 211, 212 and 213 of the smart phone 200. Accordingly, if the smart phone 200 is inserted into the insertion hole 341, the smart phone 200 is combined with the television receiver 300 in a method of naturally and electrically contacting the terminals 211, 212 and 213 provided in the smart phone 200 with the terminals 342a, 341b and 341c provided in the television receiver 300.

The television receiver unit 350 may perform a television reception function, and the television reception function can be performed regardless whether or not the smart phone 200 is combined.

As described above in the computer assistant apparatus 100, the extension unit 360 is provided to enhance usability of the smart phone 200 by providing extended functions that cannot be supported by the smart phone 200. The extension unit 360 is electrically connected to the smart phone 200 through the connection unit 340 and includes a wired connection means 361, a graphic function reinforcement means 362, an auxiliary memory means 363 and an input and output means 364. Since the extension unit 360 and specific means thereof are duplicated with those described in the computer assistant apparatus 100, details thereof will be omitted.

According to the television receiver 300 described above, it may function as a perfect mobile computer by providing a wide screen in combination with the smart phone 200, while performing the television reception function.

Accordingly, a user having a smart phone 200 does not need to separately purchase an expensive portable computer if he or she purchases only the television receiver 300.

In addition, it is preferable to implement such that voice or video communication can be performed even when the smart phone 200 is combined with the television receiver 300. Apparently, even in this case, when the user needs to move to another place (particularly when secrecy of a call is required), the smart phone 200 should keep the call connection although the smart phone 200 is detached from the television receiver 300 and moved to another place.

In addition, as shown in FIG. 5, although the computer assistant apparatus 100 or the television receiver 300 described above is shared among several users, a work required by an individual is performed in a smart phone 200A, 200B, 200C, 200D or 200E possessed by the individual, and thus the work is easy to perform, and personal information can be protected.

The preferred embodiments of the present invention will be hereafter described in detail, with reference to the accompanying drawings. Furthermore, in the drawings illustrating the embodiments of the present invention, elements having like functions will be denoted by like reference numerals and details thereon will not be repeated.

1. A computer assistant apparatus comprising:
an input unit for inputting a user command into a smart phone;
a display unit for displaying information requested to be displayed in a series of works performed in the smart phone in response to the user command inputted through the input unit; and
a connection unit electrically contacting with the smart phone in order to exchange electrical signals with the smart phone.

2. The apparatus according to claim 1, wherein the connection unit has an insertion hole for inserting the smart phone.

3. The apparatus according to claim 1, wherein the input unit is provided as a touch screen.

4. The apparatus according to claim 1, further comprising a speaker unit for outputting electrical audio signals received from the smart phone as a sound.

5. The apparatus according to claim 1, further comprising an extension unit connected to the smart phone through the connection unit and providing extended functions that cannot be provided by the smart phone.

6. The apparatus according to claim 5, wherein the extension unit includes a graphic function reinforcement means for converting a graphic received from the smart phone into a graphic fitted to a dimension of a screen provided in the display unit.

7. The apparatus according to claim 5, wherein the extension unit includes an auxiliary memory means for memorizing information received from the smart phone.

8. The apparatus according to claim 5, wherein the extension unit includes an input and output means for inputting a user command into the smart phone or outputting information received from the smart phone.

9. A television receiver comprising:
an input unit for inputting a user command into a smart phone;
a display unit for displaying information requested to be displayed in a series of works performed in the smart phone in response to the user command inputted through the input unit;
a speaker unit for outputting electrical audio signals received from the smart phone as a sound;
a connection unit electrically contacting with the smart phone in order to exchange electrical signals with the smart phone; and
a television receiver unit for performing a television reception function regardless whether or not the smart phone is combined.

10. The television receiver according to claim 9, wherein the connection unit has an insertion hole for inserting the smart phone.

11. The apparatus according to claim 9, further comprising an extension unit connected to the smart phone through the connection unit and providing extended functions that cannot be provided by the smart phone.

12. The apparatus according to claim 11, wherein the extension unit includes a graphic function reinforcement means for converting a graphic received from the smart phone into a graphic fitted to a dimension of a screen provided in the display unit.

13. The apparatus according to claim 11, wherein the extension unit includes an auxiliary memory means for memorizing information received from the smart phone.

14. The apparatus according to claim 11, wherein the extension unit includes an input and output means for inputting a user command into the smart phone or outputting information received from the smart phone.
